(19) United States
(12) Patent Application Publication
(10) Pub. No.: US 2008/0151063 A1
(43) Pub. Date: Jun. 26, 2008

(54) STAGE APPARATUS AND CAMERA SHAKE CORRECTION APPARATUS

(75) Inventor: Makoto MOGAMIYA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/961,037

(22) Filed: Dec. 20, 2007

(30) Foreign Application Priority Data
Dec. 22, 2006 (JP) 2006-345127

(51) Int. Cl. H04N 5/228

(52) U.S. Cl. 348/208.2; 348/E05.031

(57) ABSTRACT

A stage apparatus includes a stationary support board; a stage member supported by the stationary support board so as to face the stationary support board and to be movable relative to the stationary support board; a retainer, provided on one of opposed surfaces of the stage member and the stationary support board, for retaining at least three balls in a manner to allow the balls to roll on the other of the opposed surfaces; and a magnetic force generator provided on a surface of the stationary support board which faces the stage member. At least a part of the stage member, which faces the magnetic force generator, is made of a magnetic material to be magnetically attracted toward the stationary support board by a magnetic force generated by the magnetic force generator.

### BACKGROUND OF THE INVENTION

1. Field of the Invention

The present invention relates to a stage apparatus which includes a movable stage supported to be freely movable in a specific plane, and a camera shake correction apparatus of a camera which incorporates the stage apparatus.

2. Description of the Prior Art

An example of a camera shake correction apparatus (stage apparatus/image stabilizer/shake reduction system) of a camera is disclosed in Japanese unexamined patent publication 2006-108956.

This camera shake correction apparatus is provided with a stationary support plate (10) which is fixed to an internal surface of a camera body, an X-direction movable member (20) which is slidably movable in a specific X-direction while maintaining a substantially parallel state relative to the stationary support plate (10), and a Y-axis-direction movable member (30) to which an image pickup device is mounted and which is supported to be slidably movable relative to the X-direction movable member (20) in a Y-direction orthogonal to the X-direction. Three balls (BC) which are in contact with each of the stationary support plate (10) and the Y-direction movable member (30) are supported by the X-direction movable member (20) to allow the balls (BC) to rotate.

In this camera shake correction apparatus, the X-direction movable member (20) and the Y-axis-direction movable member (30) slidably move in the X-direction and the Y-direction, respectively, while making the three balls (BC) rotate to thereby correct image shake (caused by camera shake or hand shake) of an image captured by the image pickup device.

In this structure that makes sliding movements of the X-direction movable member (20) and the Y-axis-direction movable member (30) possible using the balls (BC), it is necessary to make each ball (BC) contact the stationary support plate (10) and the Y-axis-direction movable member (30). To this end, in the invention disclosed in Japanese unexamined patent publication 2006-108956, a retaining device (composed of support projections (15 and 16), pressure balls (18) and a leaf spring (19)) for pressing (biasing) the Y-direction movable member (30) toward the stationary support plate (10) is provided.

However, providing such a retaining device complicates the structure of the camera shake correction apparatus and increases the cost of production.

### SUMMARY OF THE INVENTION

The present invention provides a stage apparatus which is simple in structure though constructed using rotatable balls, and is configured to make it possible to achieve a reduction in cost of production. The present invention further provides a camera shake correction apparatus of a camera using this stage apparatus.

According to an aspect of the present invention, a stage apparatus is provided, including a stationary support board; a stage member supported by the stationary support board so as to face the stationary support board and to be movable relative to the stationary support board; a retainer, provided on one of opposed surfaces of the stage member and the stationary support board, for retaining at least three balls in a manner to allow the balls to roll on the other of the opposed surfaces; and a magnetic force generator provided on a surface of the stationary support board which faces the stage member. At least a part of the stage member, which faces the magnetic force generator, is made of a magnetic material to be magnetically attracted toward the stationary support board by a magnetic force generated by the magnetic force generator.

According to the above-described stage apparatus, the balls, which are supported by the retainer on one of the opposed surfaces of the stage member and the stationary support board, remain in contact with the other of the opposed surfaces while being allowed to rotate thereon since the magnetic material of the stage member is magnetically attracted toward the magnetic force generator (toward the stationary support board) by a magnetic force generated by the magnetic force generator that is provided on the stationary support board.

Since the balls are made to contact the stage member to be capable of rotating thereon by a magnetic force, the stage apparatus is simple in structure, which makes it possible to achieve a reduction in cost of production.

The entire stage member can be made of the magnetic material. Accordingly, the stage member can be manufactured more easily than the case where the stage member is partly made of a magnetic material.

It is desirable for the stage apparatus to include a stage-member-driving magnetic force generator, fixed to the stage member, for driving the stage member; and at least one drive coil which is fixed to the stage member and produces a driving force for driving the stage member relative to the stationary support board upon being supplied with an electric current in a state where the drive coil receives a magnetic force generated by the stage-member-driving magnetic force generator.

Accordingly, the stage member can be slidably moved by the use of magnetic force.

It is desirable for the stage-member-driving magnetic force generator to also serves as the magnetic force generator. Accordingly, the structure of the stage apparatus can be made much more easily to thereby reduce the cost of production because the stage-member-driving magnetic force generator for making the drive coil that is fixed to the stage member generate a driving force for driving the stage member can also be used as the magnetic force generator for magnetically attracting the stage member toward the stationary support board.

It is desirable for the stage-member-driving magnetic force generator to include an X-axis-direction magnetic force generator and a Y-direction magnetic force generator, wherein the drive coil includes at least one X-axis-direction drive coil which produces a driving force for driving the stage plate in an X-direction as a specific linear direction upon being supplied with an electric current in a state where the X-axis-direction drive coil receives a magnetic force generated by the X-axis-direction magnetic force generator; and at least one Y-direction drive coil which produces a driving force for driving the stage plate in a Y-direction orthogonal to the X-direction upon being supplied with an electric current in a state where the Y-axis-direction drive coil receives a magnetic force generated by the Y-axis-direction magnetic force generator. Accordingly, the stage member can be slidably moved in the X-direction and the Y-direction with the use of magnetic force.

In an embodiment, a camera shake correction apparatus is provided in a camera, the camera shake correction apparatus using the stage apparatus, including an image pickup device which includes an imaging surface on a front surface thereof and integrally moves with the stage member; a gyro sensor for detecting deflections of the camera in the X-direction; and a controller which operates to pass current through the X-direction drive coil and the Y-direction drive coil to move the stage member in a manner to compensate camera shake in accordance with information on the deflections detected by the gyro sensor. Accordingly, a camera shake correction apparatus using balls which is simpler in structure than before to thereby make it possible to achieve a reduction in cost of production can be achieved.

In an embodiment, a camera shake correction apparatus is provided in a camera, the camera shake correction apparatus using the stage apparatus, including a correction lens which integrally moves with the stage member to compensate camera shake; a gyro sensor for detecting deflections of the camera in the X-direction; and a controller which operates to pass current through the X-axis-direction drive coil and the Y-axis-direction drive coil to move the stage member in a manner to compensate camera shake in accordance with information on the deflections detected by the gyro sensor. Accordingly, a camera shake correction apparatus using balls which is simpler in structure than before to thereby make it possible to achieve a reduction in cost of production can be achieved.

It is desirable for the stage apparatus to include an electrical board on which the image pickup device is mounted and which is fixed to the stage member.

It is desirable for the X-direction drive coil and the Y-direction drive coil to be mounted on the electrical board.

It is desirable for the X-direction drive coil and the Y-direction drive coil to be made as flat coils lying in a plane parallel to both the X-direction and the Y-direction.

It is desirable for the magnetic force generator to include at least one magnet and at least one yoke, a magnetic circuit being formed between the magnet and the yoke.

It is desirable for the retainer to include three retainers fixed to the one of opposed surfaces of the stage member and the stationary support board at three different positions thereon.

It is desirable for three holes in which the three balls are partly accommodated are formed in the three retainers, respectively.

In an embodiment, a shake reduction system is provided in a camera body, including two stationary support boards fixed to each other to be parallel to each other with a predetermined space therebetween; a movable stage positioned between the two stationary support boards and supported thereby to be movable relative to the two stationary support boards while remaining parallel thereto; a retainer, provided on one of opposed surfaces of the movable stage and one of the two stationary support boards, for retaining at least three balls in a manner to allow the balls to roll on the other of the opposed surfaces; and a plurality of permanent magnets provided on a surface of the one stationary support board which faces the movable stage. At least a part of the movable stage, which faces the plurality of permanent magnets, is made of a magnetic material which is magnetically attracted toward the one stationary support board by a magnetic force generated by the plurality of permanent magnets.

In an embodiment, a stage apparatus is provided, including a stationary support board; a stage member supported by the stationary support board so as to face the stationary support board and to be movable relative to the stationary support board; a retainer, provided on one of opposed surfaces of the stage member and the stationary support board, for retaining at least three balls in a manner to allow the balls to roll on the other of the opposed surfaces; and a magnetic force generator provided on a surface of the stationary support board which faces the stage member. A surface of the stage member which faces the magnetic force generator is coated with a magnetic material to be magnetically attracted toward the stationary support board by a magnetic force generated by the magnetic force generator.

The present disclosure relates to subject matter contained in Japanese Patent Application No. 2006-345127 (filed on Dec. 22, 2006) which is expressly incorporated herein in its entirety.

### BRIEF DESCRIPTION OF THE DRAWINGS

The present invention will be discussed below in detail with reference to the accompanying drawings, in which:

FIG. 1 is a longitudinal sectional view of a camera having a camera shake correcting function;

FIG. 2 is an exploded perspective view of the camera shake correction apparatus, viewed obliquely from the front thereof;

FIG. 3 is an exploded perspective view of the camera shake correction apparatus, viewed obliquely from the rear thereof;

FIG. 4 is a front elevational view of the camera shake correction apparatus;

FIG. 5 is a rear elevational view of a front stationary support plate of the camera shake correction apparatus, and associated elements mounted to the front stationary support plate;

FIG. 6 is a front elevational view of a stage plate and associated elements mounted thereto;

FIG. 7 is a cross sectional view taken along the arrows VII-VII shown in FIG. 4;

FIG. 8 is a rear elevational view of the camera shake correction apparatus with both a rear stationary support plate and an electrical board being removed for clarity; and

FIG. 9 is a view similar to that of FIG. 1 and shows a modified embodiment of the camera shake correction apparatus according to the present invention, wherein a correction lens is provided.

### DESCRIPTION OF THE PREFERRED EMBODIMENTS

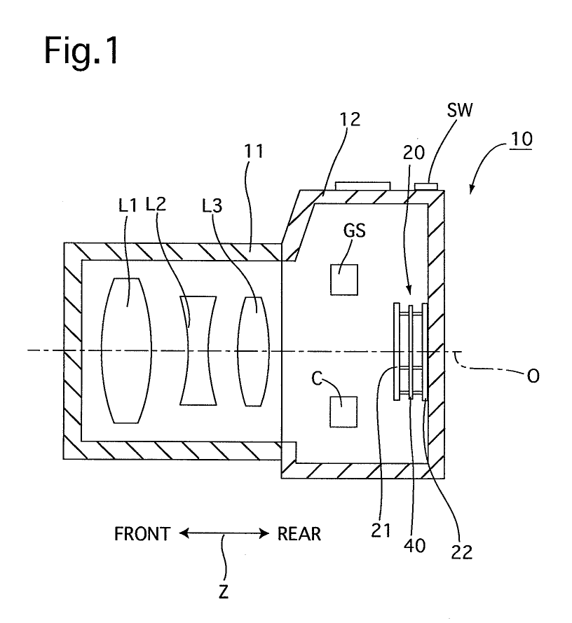

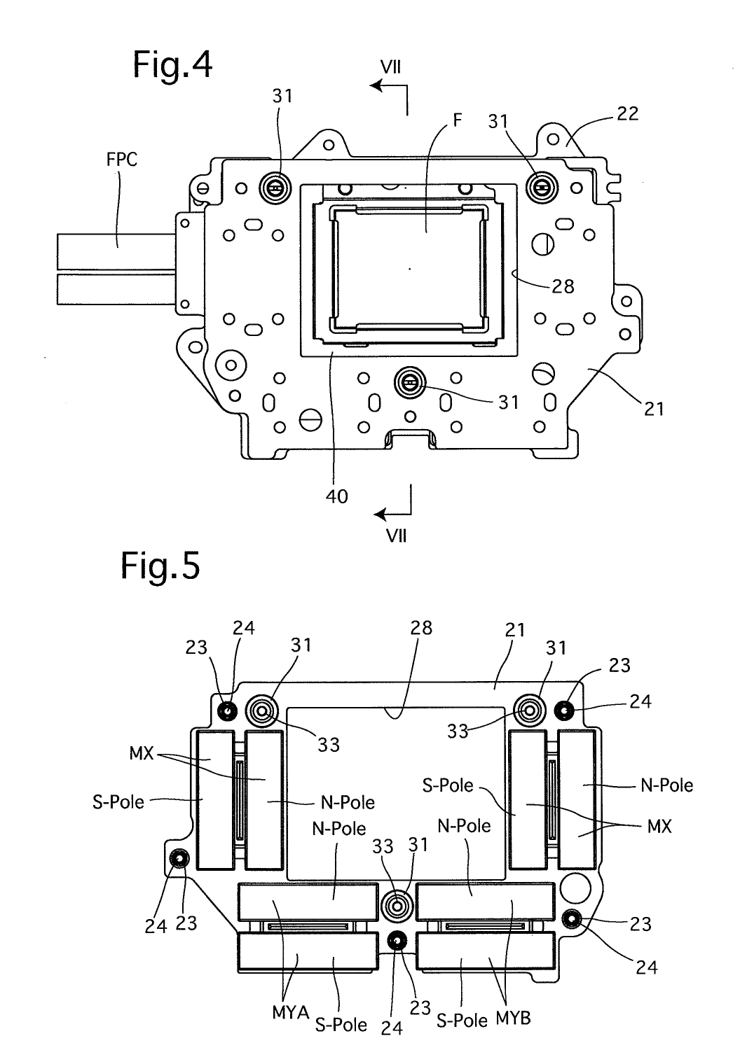

An embodiment of a camera shake correction apparatus (stage apparatus/image stabilizer/shake reduction system) 20 according to the present invention which is incorporated in a digital camera 10 will be hereinafter discussed with reference to FIGS. 1 through 8. In the following description, the horizontal direction, the vertical direction and the front-back direction of the camera shake correction apparatus 20 of the digital camera 10 are referred to as an X-direction, a Y-direction and a Z-direction, respectively.

Firstly, the basic structures of the digital camera 10 and the camera shake correction apparatus 20 will be discussed hereinafter.

As shown in FIG. 1, a lens barrel 11 mounted onto the digital camera 10 is provided therein with a photographing optical system including a plurality of lenses L1, L2 and L3, and is provided, in a camera body 12 behind the rear lens L3, with a camera shake correction apparatus 20.

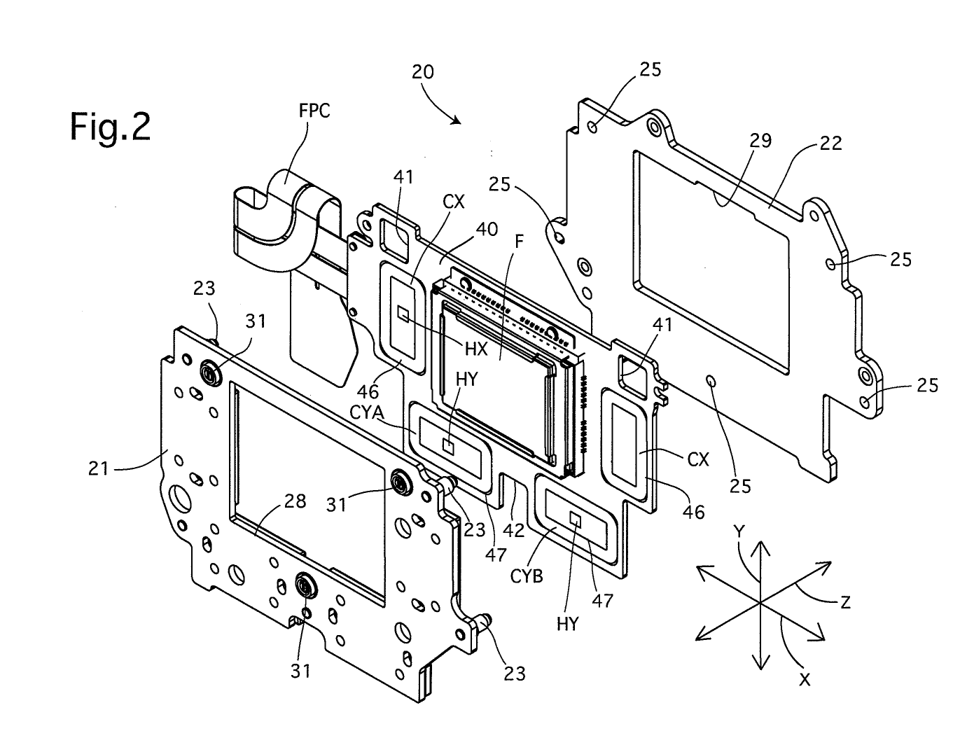

The structure of the camera shake correction apparatus 20 will be hereinafter discussed in detail with reference to FIGS. 2 through 8.

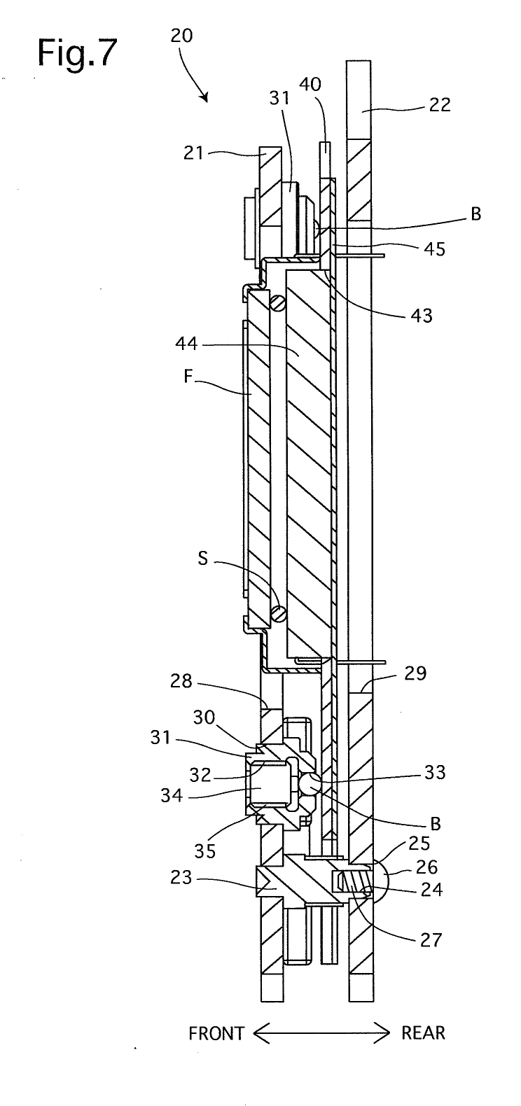

As shown in FIGS. 2 through 8, the camera shake correction apparatus 20 is provided with a front stationary support board (stationary support board) 21 and a rear stationary support board 22. The front stationary support board 21 is in the shape of a horizontally-elongated rectangle as viewed from the front and is made of a magnetic material such as a soft metal. The rear stationary support board 22 has approximately the same shape and size as the front stationary support board 21 and is made of a magnetic material such as a soft metal. The front stationary support board 21 is provided, at five different positions on the rear surface thereof, with five connecting columns 23, respectively, which project rearward, and each of the five connecting columns 23 is provided at the rear end surface thereof with a female screw hole 24. The rear stationary support board 22 is provided, at five different position thereon which correspond to the positions of the five connecting columns 23, with five through holes 25, respectively. As shown in FIG. 7, five set screws 26, each having a male screw thread portion 27, are inserted into the five through holes 25, and the male screw thread portions 27 of the five set screws 26 are screwed into the female screw holes 24 of the five connecting columns 23, respectively. Due to the screw engagement of the five set screws 26 with the five connecting columns 23, the front stationary support board 21 and the rear stationary support board 22 are connected so as to be parallel to each other.

The front stationary support board 21 is provided in a central portion thereof with a rectangular hole 28. Likewise, the rear stationary support board 22 is provided in a central portion thereof with a rectangular hole 29 behind the rectangular hole 28. The rear stationary support board 22 is fixed to an internal surface of the camera body 12 by three set screws (not shown).

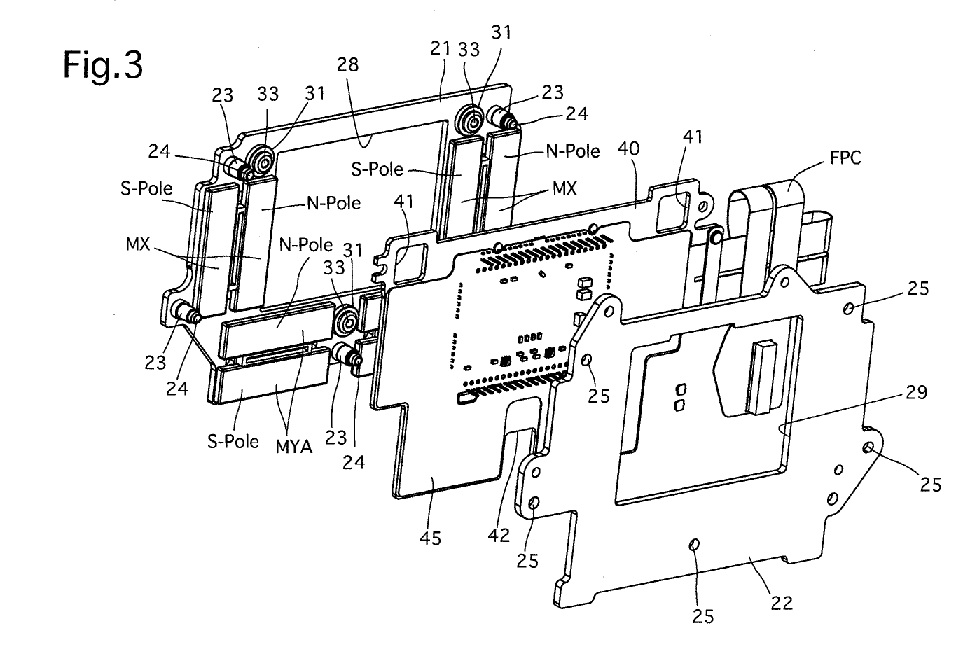

The camera shake correction apparatus 20 is provided, on the rear surface of the front stationary support board 21 at horizontally opposite ends thereof, with two (right and left) pairs of X-axis-direction magnets (permanent magnets/ elements of a magnetic force generator/elements of an X-direction magnetic force generator/a stage-member-driving magnetic force generator) MX. In each pair of X-direction magnets MX, the rear half and the front half of the left magnet as viewed in FIGS. 3 and 5 (the front half and the rear half of the right magnet as viewed from the front of the camera shake correction apparatus 20) serve as an S-pole and an N-pole, respectively, and the rear half and the front half of the right magnet as viewed in FIGS. 3 and 5 (the front half and the rear half of the left magnet as viewed from the front of the camera shake correction apparatus 20) serve as an N-pole and an S-pole, respectively. The right and left pairs of X-axis-direction magnets MX are aligned in the X-direction, and the positions of the right and left pairs of X-direction magnets MX in the Y-direction are the same. The passages of magnetic fluxes of the right and left pairs of X-direction magnets MX through the front stationary support board 21 and the rear stationary support board 22 form two X-direction magnetic circuits between the two X-axis-direction magnets MX and two portions of the rear stationary support board 22 which face the two X-direction magnets MX in the Z-direction, respectively.

The camera shake correction apparatus 20 is further provided, on the rear surface of the front stationary support board 21 below the rectangular hole 28, with two (right and left) pairs of Y-axis-direction magnets (permanent magnets/elements of a magnetic force generator/elements of a Y-axis-direction magnetic force generator/a stage-member-driving magnetic force generator) MYA and MYB which are arranged side by side in the horizontal direction, i.e., the X-direction. In each pair of Y-direction magnets MYA and MYB, the rear half and the front half of the upper magnet as viewed in FIGS. 3 and 5 serve as an N-pole and an S-pole, respectively, and the rear half and the front half of the lower magnet as viewed in FIGS. 3 and 5 serve as an S-pole and an N-pole, respectively. The passages of magnetic fluxes of the right and left pairs of Y-direction magnets MYA and MYB through the front stationary support board 21 and the rear stationary support board 22 form two Y-direction magnetic circuits between the two Y-axis-direction magnets MYA and MYB and two portions of the rear stationary support board 22 which face the two Y-direction magnets MYA and MYB in the Z-direction, respectively.

Accordingly, the front stationary support board 21 and the rear stationary support board 22 function as yokes.

As shown in FIG. 7, the front stationary support board 21 is provided at three different positions thereon with three fitting holes (through holes) 30, respectively (only one of them is shown in FIG. 7). Substantially cylindrical-shaped three retainers 31, the front ends of which are provided with open ends, are fixedly fitted into the three fitting holes 30, respectively. Each retainer 31 is provided therein with a female screw hole 32. Each retainer 31 is further provided, in the center of the rear end wall thereof behind the female screw hole 32 in the Z-direction, with a support hole (through hole) 33 which is smaller in diameter than the female screw hole 32 and aligned with the female screw hole 32. A column-shaped adjustment screw member 34 made of metal is screwed into each retainer 31 with a male screw thread 35 which is formed on the outer peripheral surface of the adjustment screw member 34 being screw-engaged with the female screw hole 32 of the retainer 31. Additionally, each adjustment screw member 34 is provided on the front end surface thereof with a screwdriver insertion slot (not shown) into which the blade of a screwdriver can be engaged.

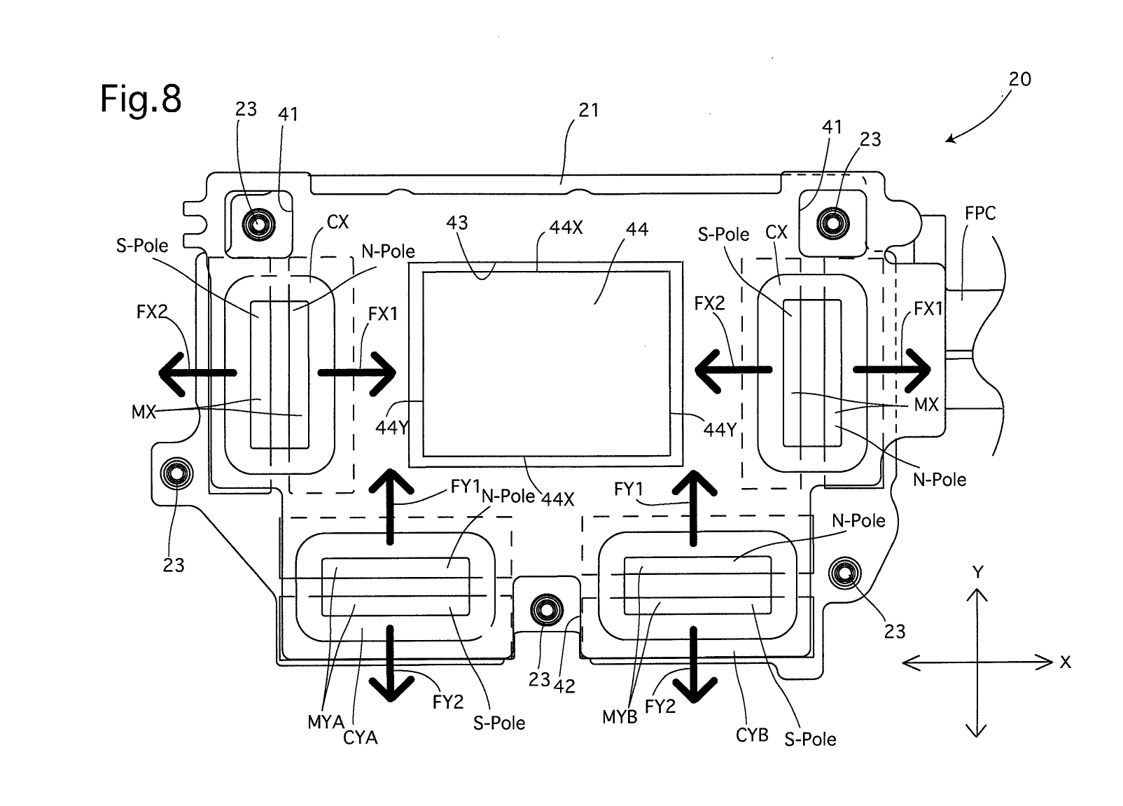

The camera shake correction apparatus 20 is provided between the front stationary support board 21 and the rear stationary support board 22 with a stage plate (stage member) 40. The stage plate 40 is made of a magnetic material such as a soft metal and press-molded in one piece. The stage plate 40 is provided in the upper right corner and the upper left corner thereof with two moving range limit holes 41, respectively. Additionally, the stage plate 40 is further provided, at the lower end thereof at the center in the horizontal direction, with a moving range limit recess 42. As shown in FIG. 8, two of the five connecting columns 23 which project from the front stationary support board 21 in the vicinity of the right and left upper corners thereof pass through the two moving range limit holes 41 of the stage plate 40 in the Z-direction, respectively, while one of the five connecting columns 23 which projects from the lower end of the front stationary support board 21 at the center thereof in the horizontal direction passes through the moving range limit recess 42 of the stage plate 40 in the Z-direction.

The stage plate 40 is provided in the center thereof with an image-pickup-device mounting hole 43 that is rectangular in shape as viewed from the front (see FIGS. 7 and 8). As shown in FIGS. 3 and 7, an image pickup device 44 is fixed to an electrical board 45 on a central portion of the front surface thereof, and the electrical board 45 is fixed to the back of the stage plate 40 with the image pickup device 44 projecting forward from the stage plate 40 through the image-pickup-device mounting hole 43. A combination of the stage plate 40 and the electrical board 45 that is fixed to the back of the stage plate 40 serves as a movable stage which is integral with the image pickup device 44. As shown in FIG. 7, the camera shake correction apparatus 20 is provided immediately in front of the image pickup device 44 with an optical low-pass filter F that is rectangular in shape as viewed from the front, with a spacer S provided in between the optical low-pass filter F and the image pickup device 44.

As shown in FIG. 8, the image pickup device 44 is provided with a pair of X-direction edges (upper and lower X-direction edges) 44X which extend parallel to each other in the X-direction and a pair of Y-direction edges (right and left Y-direction edges) 44Y which extend parallel to each other in the Y-direction when the stage plate 40 is in the position (initial position) shown in FIG. 8. The imaging surface of the image pickup device 44 is an image-forming surface on which object light which is passed through the lenses L1, L2 and L3 and the optical low-pass filter F is formed as an object image. When the stage plate 40 is in the initial position (when the stage plate 40 is in the state shown in FIG. 8), the center of the imaging surface of the image pickup device 44 is positioned on an optical axis O of the lenses L1, L2 and L3.

The stage plate 40 is provided on the horizontally opposite sides of the image pickup device 44 with a pair of coil mounting holes 46 that are vertically elongated, respectively, and is further provided below the image pickup device 44 with a pair of coil mounting holes 47 that are horizontally-elongated.

Two X-direction drive coils (flat coils) CX having the same specifications are fixedly mounted on the front surface of the electrical board 45 and fitted in the pair of coil mounting holes 46, respectively. The two X-direction drive coils CX lie in a plane parallel to an X-Y axis plane and are aligned in a direction parallel to the pair of X-direction edges 44X of the image pickup device 44 (in the X-direction in the state shown in FIG. 8). In other words, the positions of the two X-direction drive coils CX in the direction parallel to the pair of Y-direction edges 44Y (in the Y-direction in the state shown in FIG. 8) are coincident with each other. Each X-direction drive coil CX is rectangularly coiled (both in the direction parallel to the stage plate 40 and in the direction of thickness of the stage plate 40) to have over one hundred turns. The two X-direction drive coils CX are positioned to correspond to the aforementioned two X-direction magnetic circuits (the front stationary support board 21, the rear stationary support board 22 and the two X-direction magnets MX), respectively. In other words, the two X-direction drive coils CX are positioned to face the two X-direction magnets MX in the Z-direction, respectively.

Two Y-direction drive coils (flat coils) CYA and CYB having the same specifications are fixedly mounted on the front surface of the electrical board 45 and fitted in the pair of coil mounting holes 47, respectively. The two Y-direction drive coils CYA and CYB lie in a plane parallel to an X-Y axis plane and are aligned in a direction parallel to the pair of X-direction edges 44X of the image pickup device 44 (in the X-direction in the state shown in FIG. 8). In other words, the positions of the two Y-direction drive coils CYA and CYB in the direction parallel to the pair of Y-direction edges 44Y (in the Y-direction in the state shown in FIG. 8) are coincident with each other. Each Y-direction drive coil CYA and CYB is rectangularly coiled (both in the direction parallel to the stage plate 40 and in the direction of thickness of the stage plate 40) to have over one hundred turns. The two Y-direction drive coils CYA and CYB are positioned to correspond to the aforementioned two Y-direction magnetic circuits (the front stationary support board 21, the rear stationary support board 22 and the two Y-direction magnets MY), respectively. In other words, the two Y-direction drive coils CYA and CYB are positioned to face the two Y-direction magnets MY in the Z-direction, respectively.

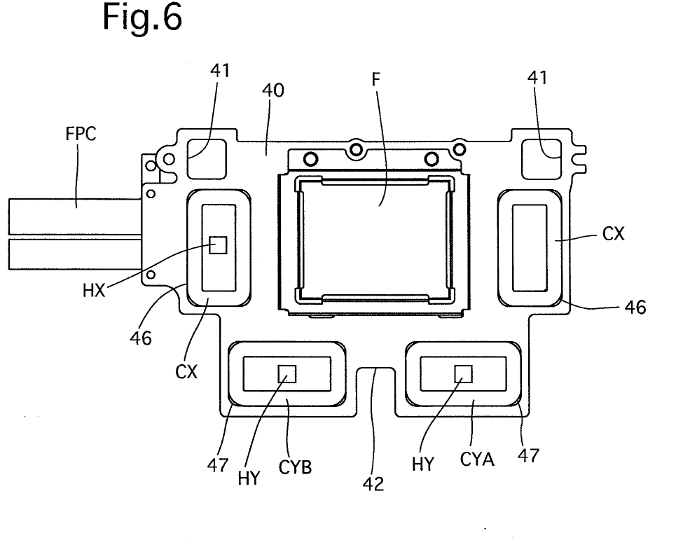

As shown in FIGS. 2 and 6, an X-direction Hall element HX is fixed to the front surface of the electrical board 45 to be positioned inside of the left X-direction drive coil CX, and two Y-direction Hall elements HY are fixed to the front surface of the electrical board 45 to be positioned inside of the two Y-direction drive coils CYA and CYB, respectively.

The two X-axis-direction drive coils CX, the two Y-direction drive coils CYA and CYB, the X-direction Hall element HX and the two Y-direction Hall elements HY are all electrically connected to a controller C (see FIG. 1) via a flexible printed circuit board FPC which extends from the stage plate 40. The controller C is constructed from a CPU or the like incorporated in the camera body 12.

As shown in FIG. 7, three balls B having substantially the same diameter as the support holes 33 of the three retainers 31 are partly accommodated in the support holes 33 of the three retainers 31 that project from the front stationary support board 21 toward the stage plate 40 to be freely rotatable in the support holes 33, respectively. Portions of the stage plate 40 which face the two pairs of X-direction magnets MX and the two pairs of Y-axis-direction magnets MYA and MYB are magnetically attracted toward the front stationary support board 21 due to the magnetic force generated by the two pairs of X-direction magnets MX and the two pairs of Y-axis-direction magnets MYA and MYB, which are fixed to the back of the front stationary support board 21. Therefore, these portions of the stage plate 40 remain in contact with the three balls B to allow the three balls B to roll thereon, while the three balls B remain in contact with rear end surfaces of the adjustment screw members 34 to be allowed to rotate in the support holes 33 of the three retainers 31, respectively.

Since the front surface of the stage plate 40 remains in contact with the three balls B to allow the three balls B to roll thereon, the stage plate 40 and the image pickup device 44 can not only move linearly in the X-direction and the Y-direction relative to the front stationary support board 21 and the rear stationary support board 22 but also rotate in an X-Y axis plane that is parallel to both the X-direction and the Y-direction (i.e., that is orthogonal to the optical axis O).

Additionally, since three of the five connecting columns 23 that project from the front stationary support board 21 are loosely engaged in the two moving range limit holes 41 and the moving range limit recess 42 of the stage plate 40, respectively, the range of sliding movement of the stage plate 40 and the electrical board 45 (the image pickup device 44) is limited by the three connecting columns 23, the two moving range limit holes 41 and the moving range limit recess 42 Therefore, the two X-direction drive coils CX remain opposed to the two pairs of X-axis-direction magnets MX in the Z-direction, respectively, the X-direction Hall element HX remains opposed to the left X-direction magnet MX (the right X-direction magnet MX as viewed in FIGS. 3, 5 and 8) in the Z-direction, the Y-axis-direction drive coil CYA and the associated Y-direction Hall element HY positioned thereinside remain opposed to the pair of Y-direction magnet MYA in the Z-direction, and the Y-direction drive coil CYB and the associated Y-direction Hall element HY positioned thereinside remain opposed to the pair of Y-direction magnet MYB in the Z-direction.

The camera shake correction apparatus 20 carries out a shake correction operation (image stabilizing operation) so as to offset image shake by passing currents through the two X-direction drive coils CX and the two Y-axis-direction drive coil CYA and CYB from the controller C.

More specifically, if camera shake (deflections) in the X-direction or the Y-direction, which is caused by hand shake, occurs while a camera shake correction switch SW (see FIG. 1) provided on the camera body 12 is depressed (in an ON state), a gyro sensor GS (see FIG. 1) detects the angular velocity in the X-direction and the angular velocity in the Y-direction. Thereupon, based on data on these angular velocities, the controller C calculates the moving distance (amount of camera shake) in the X-direction and the moving distance (amount of camera shake) in the Y-direction, and passes a current through at least one of the two X-direction drive coils CX and the two Y-axis-direction drive coil CYA and CYB. Thereupon, at least one of the two X-direction drive coils CX and the two Y-axis-direction drive coil CYA and CYB generates a driving force in associated one of the driving directions (FX1 or FX2, or FY1 or FY2) shown by the thick-line arrows in FIG. 8 to move the image pickup device 44 (the stage plate 40) linearly in the X-direction or the Y-direction relative to the camera body 12 in the direction opposite to the direction of the camera shake by a moving distance identical to the amount of the camera shake (note that the moving distances of the stage plate 40 in the X-direction and the Y-direction are detected by the X-direction Hall element HX and the two Y-direction Hall elements HY), and accordingly, the effects of shake of the image pickup device 44 (image shake) that is caused by hand shake or the like are compensated (corrected).

According to the above described embodiment of the camera shake correction apparatus, since the front stationary support board 21 (and the rear stationary support board 22) and the stage plate 40 (and the electrical board 45) are maintained substantially parallel to each other via the use of the magnetic force generated by the two pairs of X-direction magnets MX and the two pairs of Y-axis-direction magnets MYA and MYB, the camera shake correction apparatus is simpler in structure than a conventional camera shake correction apparatus which includes a retaining device (such as disclosed in the aforementioned Japanese unexamined patent publication 2006-108956) for pressing (biasing) the back of a movable stage (which corresponds to a combination of the stage plate 40 and the electrical board 45) forward; moreover, the camera shake correction apparatus can be made at a low cost of production.

Moreover, the camera shake correction apparatus is not required to be provided with any additional magnet in order for the front stationary support board 21 and the stage plate 40 to be maintained substantially parallel to each other since the two pairs of X-direction magnets MX and the two pairs of Y-axis-direction magnets MYA and MYB, which serve as a device for driving the stage plate 40 (movable stage) with respect to the camera body 12, are used as a device for the front stationary support board 21 and the stage plate 40 to be maintained substantially parallel to each other. This makes it possible to achieve a reduction in number of elements of the present embodiment of the camera shake correction apparatus 20.

Furthermore, adjusting the three adjustment screw members 34 as appropriate using a screwdriver (not shown) by rotating the screwdriver with the blade thereof being engaged in the screwdriver insertion slot of each screw member 34 to be adjusted achieves a change in position of the screw member 34 in the Z-direction relative to the associated retainer 31. Therefore, if the angle of inclination of the stage plate 40 relative to the front stationary support board 21 and the rear stationary support board 22 is adjusted by adjusting the positions of the three adjustment screw members 34 (the three balls B) as appropriate in the Z-direction, the imaging surface of the image pickup device 44 can be easily adjusted to be orthogonal to the optical axis O of the lenses L1, L2 and L3.

Furthermore, the stage plate 40 can be easily manufactured because the stage plate 40 is press-molded of a magnetic material in one piece.

Although the present invention has been discussed with reference to the above described embodiment of the camera shake correction apparatus, the present invention is not limited solely to this particular embodiment; making various modifications to the adjusting device is possible.

For instance, it is possible that only portions of the stage plate 40 which face the two pairs of X-axis-direction magnets MX and the two pairs of Y-direction magnets MYA and MYB be made of a magnetic material and that the remaining portion of the stage plate 40 that does not face either of the two pairs of X-axis-direction magnets MX and the two pairs of Y-direction magnets MYA and MYB be made of a non-magnetic material.

In addition, it is possible that a magnetic plating (magnetic material) be provided on the front surface (either entirely or only on portions thereof which face the two pairs of X-axis-direction magnets MX and the two pairs of Y-direction magnets MYA and MYB) of the stage plate 40 (a high temperature treatment is applied to an electroless nickel plating if it is adopted as a plating of a magnetic material provided the front surface of the stage plate 40) and that the magnetic force generated by the two pairs of X-direction magnets MX and the two pairs of Y-axis-direction magnets MYA and MYB be exerted on the magnetic plating to attract the stage plate 40 magnetically toward the front stationary support board 21.

Additionally, it is possible that the three retainers 31 be installed on a surface (front surface) of the rear stationary support board 22 which faces the stage plate 40, so that the balls B are made to contact the rear surface of the stage plate 40 to be allowed to rotate, and that the two pairs of X-direction magnets MX and the two pairs of Y-axis-direction magnets MYA and MYB be fixed to the front surface of the rear stationary support board 22 (if a magnetic plating is used, it is applied to the rear surface of the stage plate 40).

Additionally, it is possible that the three retainers 31 be installed to the front surface or the rear surface of the stage plate 40 and that the three balls B that are respectively supported by the three retainers 31 be made to contact the rear surface of the front stationary support board 21 or the front surface of the rear stationary support board 22 to be allowed to rotate.

Additionally, the number of the retainers 31 and the number of the balls B can be more than three.

Alternatively, it is possible for at least one of the retainers (31) to retain more than one ball B or for one single retainer (31) to retain all of the balls B.

Additionally, it is possible that one or more magnets other than the magnets MX, MYA and MYB be fixed to the front stationary support board 21 to attract the stage plate 40 toward the front stationary support board 21 (or the rear stationary support board 22) by the magnetic force generated by such a magnet(s).

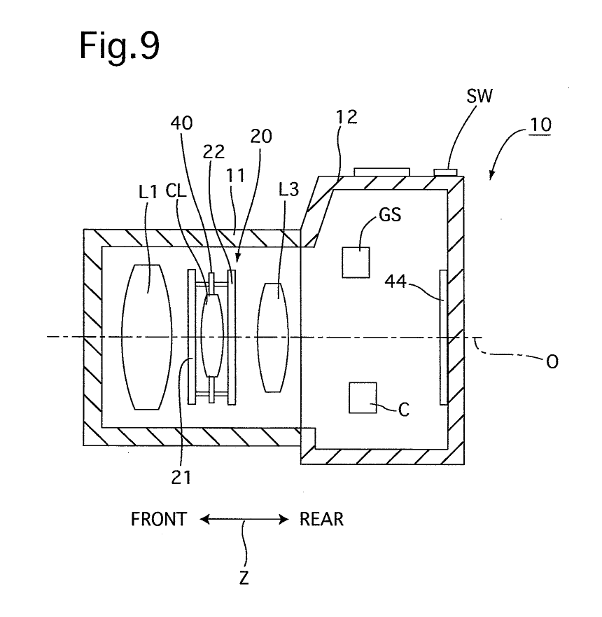

In addition, as shown in FIG. 9, it is possible for the camera shake correction apparatus 20 to be installed between the lenses L1 and L3 (the positional relationship between the camera shake correction apparatus 20 and the other lenses is not limited to the arrangement shown in FIG. 9), a through hole serving as a lens retaining hole to be formed in a central portion of a combination of the stage plate 40 and the electrical board 45, a correction lens CL to be fitted and secured to the lens mounting hole so that the correction lens CL is integral with the stage plate 40, and for the image pickup device 44 that is positioned immediately behind the lens L3 to be installed in the camera body 12 (for example, fixed to an internal wall thereof). Even if the correction lens CL is linearly moved in the X-direction and the Y-direction by the camera shake correction apparatus 20 in the above-described manner, it is possible to compensate, i.e., cancel out, the effects of hand shake. Additionally, the camera shake correction apparatus using the correction lens CL of this type can be applied to a silver-halide film camera which does not use an image pickup device such as the image pickup device 44.

Although the present invention has been applied to the above described embodiment of the camera shake correction apparatus 20, in which the stage plate 40 (and the electrical board 45) is rotatable, the present invention can also be applied to a conventional camera shake correction apparatus in which a stage plate and an electrical board (which correspond to the stage plate 40 and the electrical board 45, respectively) which move only linearly in the X-direction and the Y-direction, and can be applied even to a stage apparatus used for a different purpose other than the purpose of correcting image shake.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A stage apparatus comprising:
a stationary support board;
a stage member supported by said stationary support board so as to face said stationary support board and to be movable relative to said stationary support board;
a retainer, provided on one of opposed surfaces of said stage member and said stationary support board, for retaining at least three balls in a manner to allow said balls to roll on the other of said opposed surfaces; and
a magnetic force generator provided on a surface of said stationary support board which faces said stage member,
wherein at least a part of said stage member, which faces said magnetic force generator, is made of a magnetic material to be magnetically attracted toward said stationary support board by a magnetic force generated by said magnetic force generator.

2. The stage apparatus according to claim 1, wherein the entire said stage member is made of said magnetic material.

3. The stage apparatus according to claim 1, further comprising:
a stage-member-driving magnetic force generator, fixed to said stage member, for driving said stage member; and
at least one drive coil which is fixed to said stage member and produces a driving force for driving said stage member relative to said stationary support board upon being supplied with an electric current in a state where said drive coil receives a magnetic force generated by said stage-member-driving magnetic force generator.

4. The stage apparatus according to claim 3, wherein said stage-member-driving magnetic force generator also serves as said magnetic force generator.

5. The stage apparatus according to claim 3, wherein said stage-member-driving magnetic force generator comprises an X-axis-direction magnetic force generator and a Y-direction magnetic force generator,
wherein said drive coil comprises:
at least one X-axis-direction drive coil which produces a driving force for driving said stage plate in an X-direction as a specific linear direction upon being supplied with an electric current in a state where said X-axis-direction drive coil receives a magnetic force generated by said X-axis-direction magnetic force generator; and
at least one Y-direction drive coil which produces a driving force for driving said stage plate in a Y-direction orthogonal to said X-direction upon being supplied with an electric current in a state where said Y-axis-direction drive coil receives a magnetic force generated by said Y-axis-direction magnetic force generator.

6. A camera shake correction apparatus provided in a camera, said camera shake correction apparatus using said stage apparatus according to claim 5, comprising:
an image pickup device which includes an imaging surface on a front surface thereof and integrally moves with said stage member;
a gyro sensor for detecting deflections of said camera in said X-direction; and
a controller which operates to pass current through said X-direction drive coil and said Y-direction drive coil to move said stage member in a manner to compensate camera shake in accordance with information on said deflections detected by said gyro sensor.

7. A camera shake correction apparatus provided in a camera, said camera shake correction apparatus using said stage apparatus according to claim 5, comprising:
a correction lens which integrally moves with said stage member to compensate camera shake;
a gyro sensor for detecting deflections of said camera in said X-direction; and
a controller which operates to pass current through said X-axis-direction drive coil and said Y-axis-direction drive coil to move said stage member in a manner to compensate camera shake in accordance with information on said deflections detected by said gyro sensor.

8. The stage apparatus according to claim 6, further comprising an electrical board on which said image pickup device is mounted and which is fixed to said stage member.

9. The stage apparatus according to claim 8, wherein said X-direction drive coil and said Y-direction drive coil are mounted on said electrical board.

10. The stage apparatus according to claim 9, wherein said X-direction drive coil and said Y-direction drive coil are made as flat coils lying in a plane parallel to both said X-direction and said Y-direction.

11. The stage apparatus according to claim 1, wherein said magnetic force generator comprises at least one magnet and at least one yoke, a magnetic circuit being formed between said magnet and said yoke.

12. The stage apparatus according to claim 1, wherein said retainer comprises three retainers fixed to said one of opposed surfaces of said stage member and said stationary support board at three different positions thereon.

13. The stage apparatus according to claim 12, wherein three holes in which said three balls are partly accommodated are formed in said three retainers, respectively.

14. A shake reduction system provided in a camera body, comprising:
two stationary support boards fixed to each other to be parallel to each other with a predetermined space therebetween;
a movable stage positioned between said two stationary support boards and supported thereby to be movable relative to said two stationary support boards while remaining parallel thereto;
a retainer, provided on one of opposed surfaces of said movable stage and one of said two stationary support boards, for retaining at least three balls in a manner to allow said balls to roll on the other of said opposed surfaces; and
a plurality of permanent magnets provided on a surface of said one stationary support board which faces said movable stage,
wherein at least a part of said movable stage, which faces said plurality of permanent magnets, is made of a magnetic material which is magnetically attracted toward said one stationary support board by a magnetic force generated by said plurality of permanent magnets.

15. A stage apparatus comprising:
a stationary support board;
a stage member supported by said stationary support board so as to face said stationary support board and to be movable relative to said stationary support board;
a retainer, provided on one of opposed surfaces of said stage member and said stationary support board, for retaining at least three balls in a manner to allow said balls to roll on the other of said opposed surfaces; and
a magnetic force generator provided on a surface of said stationary support board which faces said stage member,
wherein a surface of said stage member which faces said magnetic force generator is coated with a magnetic material to be magnetically attracted toward said stationary support board by a magnetic force generated by said magnetic force generator.

16. The stage apparatus according to claim 15, wherein the entire said stage member is made of said magnetic material.

17. The stage apparatus according to claim 15, further comprising:
a stage-member-driving magnetic force generator, fixed to said stage member, for driving said stage member; and
at least one drive coil which is fixed to said stage member and produces a driving force for driving said stage member relative to said stationary support board upon being supplied with an electric current in a state where said drive coil receives a magnetic force generated by said stage-member-driving magnetic force generator.

18. The stage apparatus according to claim 17, wherein said stage-member-driving magnetic force generator also serves as said magnetic force generator.

19. The stage apparatus according to claim 17, wherein said stage-member-driving magnetic force generator comprises an X-axis-direction magnetic force generator and a Y-direction magnetic force generator,
wherein said drive coil comprises:
at least one X-axis-direction drive coil which produces a driving force for driving said stage plate in an X-direction as a specific linear direction upon being supplied with an electric current in a state where said X-axis-direction drive coil receives a magnetic force generated by said X-axis-direction magnetic force generator; and
at least one Y-direction drive coil which produces a driving force for driving said stage plate in a Y-direction orthogonal to said X-direction upon being supplied with an electric current in a state where said Y-axis-direction drive coil receives a magnetic force generated by said Y-axis-direction magnetic force generator.

20. A camera shake correction apparatus provided in a camera, said camera shake correction apparatus using said stage apparatus according to claim 19, comprising:
an image pickup device which includes an imaging surface on a front surface thereof and integrally moves with said stage member;
a gyro sensor for detecting deflections of said camera in said X-direction; and
a controller which operates to pass current through said X-direction drive coil and said Y-direction drive coil to move said stage member in a manner to compensate camera shake in accordance with information on said deflections detected by said gyro sensor.

21. A camera shake correction apparatus provided in a camera, said camera shake correction apparatus using said stage apparatus according to claim 19, comprising:
a correction lens which integrally moves with said stage member to compensate camera shake;
a gyro sensor for detecting deflections of said camera in said X-direction; and
a controller which operates to pass current through said X-axis-direction drive coil and said Y-axis-direction drive coil to move said stage member in a manner to compensate camera shake in accordance with information on said deflections detected by said gyro sensor.

22. The stage apparatus according to claim 20, further comprising an electrical board on which said image pickup device is mounted and which is fixed to said stage member.

23. The stage apparatus according to claim 22, wherein said X-direction drive coil and said Y-direction drive coil are mounted on said electrical board.

24. The stage apparatus according to claim 23, wherein said X-direction drive coil and said Y-direction drive coil are made as flat coils lying in a plane parallel to both said X-direction and said Y-direction.

25. The stage apparatus according to claim 15, wherein said magnetic force generator comprises at least one magnet and at least one yoke, a magnetic circuit being formed between said magnet and said yoke.

26. The stage apparatus according to claim 15, wherein said retainer comprises three retainers fixed to said one of opposed surfaces of said stage member and said stationary support board at three different positions thereon.

27. The stage apparatus according to claim 26, wherein three holes in which said three balls are partly accommodated are formed in said three retainers, respectively.
